(19) United States
(12) Patent Application Publication
(10) Pub. No.: US 2008/0037967 A1
(43) Pub. Date: Feb. 14, 2008

(54) Heating Device for Fuel

(75) Inventors: Michael FASOLD, Auenwald (DE); Sascha BAUER, Auenwald (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/851,624

(22) Filed: Sep. 7, 2007

Related U.S. Application Data
(63) Continuation of application No. PCT/EP2006/060324, filed on Feb. 8, 2006.

(30) Foreign Application Priority Data
Mar. 9, 2005 (DE) 10 2005 011 182.3

(51) Int. Cl. B60L 1/02; H05B 3/78

(52) U.S. Cl. 392/451; 219/205

(57) ABSTRACT

A heating device for fuel comprising an electric heating element (5), which is mounted on a carrier body (4). The carrier body (4) surrounds the heating element (5), and an insulating protective layer coating (7) is applied to the carrier body.

### CROSS REFERENCE TO RELATED APPLICATIONS

This application is a continuation of international patent application no. PCT/EP2006/060324, filed Feb. 28, 2006 designating the United States of America and published in German on Sep. 14, 2006 as WO 2006/094921, the entire disclosure of which is incorporated herein by reference. Priority is claimed based on Federal Republic of Germany patent application no. DE 10 2005 011 182.3, filed Mar. 9, 2005.

### BACKGROUND OF THE INVENTION

The invention relates to a heating device for fuel, particularly diesel fuel for a motor vehicle.

U.S. Pat. No. 6,493,508 (=DE 199 55 206) discloses a fuel filter for internal combustion engines with an integrated fuel heating unit to heat the fuel of the internal combustion engine. The fuel is heated to keep it liquid at low temperatures below 0° C. because components such as paraffins contained particularly in diesel fuels become viscous or solid at these temperatures. If the fuel is not heated, the fuel lines and fuel filters become clogged, so that proper functioning of the internal combustion engine is no longer ensured.

The heating device integrated into the fuel filter is an electric resistance heater and comprises an electric heating coil placed onto a substrate which is in turn applied to a heat transfer body. To prevent the aggressive chemical behavior of the fuel from damaging the heating coil and the electronic elements likewise applied to the substrate and to prevent undesirable electrolysis of the fuel, the electronic elements and the heating coil are coated with a protective film. This protective film prevents direct contact between the fuel and the heating coil or the electronic elements.

To simplify manufacture it may be desirable, however, to prevent direct contact between the protective film and the heating coil.

### SUMMARY OF THE INVENTION

It is an object of the present invention to provide an improved heating device for fuels.

Another object of the invention is to provide a heating device for fuel which has a simple and cost effective construction.

A further object of the invention is to provide a heating device for fuel which is highly chemically and thermally resistant to fuels.

These and other object are achieve in accordance with the present invention by providing a heating device for fuel comprising an electric heating element supported on a carrier body and a protective film insulating the heating element relative to the fuel to be heated, wherein the carrier body encloses the heating element, and the protective film is applied to the carrier body.

Advantageous further embodiments are described in detail hereinafter.

In the heating device according to the invention, the electric heating element is surrounded by the carrier body, which therefore fulfills not only a carrying function but also a protective function, since the heating element is supported and enclosed by the carrying body. It is further provided that the protective film is applied to the carrying body. In this manner, the heating element does not come into direct contact with the protective film. Chemical resistance against the fuel is achieved by applying the protective film to the carrying body. On the other hand, there is no need to apply the protective film to the heating element. This makes it possible to manufacture the heating element and the carrying body including the coating in independent process steps before assembly. Coating the carrying body, which is typically a simple structure, is usually easier than coating the heating element.

Because the heating element is enclosed in the carrier body, no additional means to secure the heating element to the carrier body are necessary. It is basically sufficient to simply provide an indentation or a projection or the like in the carrier body to clamp the heating element within the carrier body.

Another advantage can be achieved by making the carrier body of an electrically conductive material, so that it has not only a supporting or carrying function but is also electrically conductive and enables current to flow through the heating element. There is preferably a direct contact between the heating element and the carrier body, so that no additional electrically conductive connections are necessary between the carrier body and the heating element. In this embodiment, the carrying body not only carries and protects the element but also acts as an electric conductor.

To close the circuit, it is advantageous to provide a contact element formed separately from the carrier body and in electrical contact with the heating element. A closed circuit is obtained via the carrier body, the heating element and the additional contact element. The carrier body and the contact element are connected to different poles of the electrical circuit and are electrically isolated from each other to prevent a short circuit.

In another advantageous embodiment, the heating device comprises two heating elements, between which the contact element is disposed and the exterior of which is enclosed by the carrier body. In this configuration, a greater heating capacity is obtained, but compared to configurations with only a single heating element, the complexity with regard to mounting and electrically connecting the heating elements is increased only slightly. Due to its position between the two heating elements, the contact element is also safely electrically isolated from the carrier body.

Since the carrier body is highly chemically resistant to the fuel because of the protective film applied thereto, there are no high requirements regarding the material selection for the carrier body. In principle it is sufficient to use simple materials, such as sheet metal, distinguished by their good and easy forming properties. This makes it possible in particular to manufacture a one-piece carrier body enclosing the heating element or heating elements on two different sides, e.g., by sheet metal forming. To increase the surface of the carrier body, turbulence embossments may be formed. The resulting increase of the surface area improves the heat transfer from the heating element to the fluid to be heated. These turbulence embossments may, for example, be formed as loops, so that a partial fluid stream flows through these turbulence embossments.

The insulating protective film applied to the exterior of the carrier body is preferably a ceramic coating, for example an oxide-resin-based aluminum oxide coating, which may also include carbon particles. Ceramic coatings or ceramic adhesives of this type may also be used to manufacture a base to which the carrier body is secured. The protective film preferably extends over the entire outer shell of the carrier body up to said base to ensure that the protective film is continuous.

### BRIEF DESCRIPTION OF THE DRAWINGS

The invention will be described in further detail hereinafter with reference to illustrative preferred embodiments shown in the accompanying drawing figures, in which:

FIG. 1 is a partially cutaway side view of a heating device for fuels, shown in its installation position inside a housing and comprising a base, a bent carrier body formed of sheet metal and two heating elements held in the carrier body, with a strip-shaped contact element disposed therebetween, which is likewise held on the base, such that the outside sheath of the carrier body is coated by an insulating protective film;

FIG. 1a shows a modified embodiment of the heating device depicted in FIG. 1;

FIG. 2 is a view of the end face of the base;

FIG. 2a is a sectional view of the heating device taken along line A-A of FIG. 1a;

FIG. 2b is a sectional view of the heating device taken along line B-B of FIG. 1a;

FIG. 3 is a perspective view of the heating element;

FIG. 3a illustrates a modified embodiment of the heating element depicted in FIG. 3;

FIG. 4 is a top view of the heating element;

FIG. 4a shows a modified embodiment of the heating element depicted in FIG. 4;

FIG. 5 is another perspective view of the heating element, and

FIG. 5a shows a modified embodiment of the heating element depicted in FIG. 5.

### DETAILED DESCRIPTION OF PREFERRED EMBODIMENTS

In the figures like parts are identified by the same reference numerals.

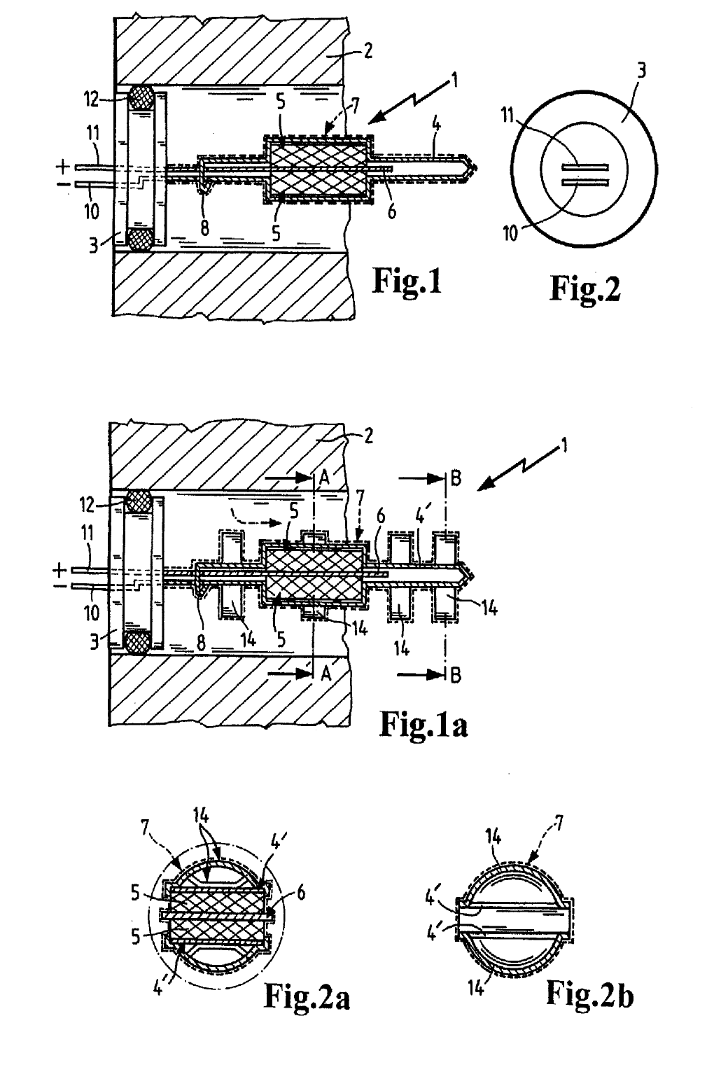

FIG. 1 shows the fuel heating device 1 when installed in a housing 2 of a unit, such as a fuel filter, for example. The heating device 1 comprises a disk-shaped base 3 holding the carrier body 4, which is formed of sheet metal. The base 3 is made of an electrically insulating material, particularly a ceramic coating or adhesive, into which the plate-shaped carrier body 4 is cast. The base 3 held inside the housing 2 is sealed in relation to the housing by means of a sealing ring 12.

In the area of its free end face, the carrier body 4 is bent to form a holding space between two side faces, into which two superimposed electric heating elements 5 are inserted. Each side piece of the carrier body 4 has an indentation with a heating element 5 inserted in each. In this manner, the heating elements 5 are fixed in longitudinal and transverse direction of the carrier body 4. In vertical direction, the heating elements 5 are also firmly enclosed because the respective exteriors of the heating elements 5 directly adjoin the interior wall of the sheet metal side piece of the carrier body 4. Since the carrier body 4 is formed of sheet metal or another electrically conductive material, an electrical contact is established between the carrier body 4 and the exterior of the heating elements 5.

Between the two heating elements 5, a bar-shaped or strip-shaped contact element 6 is inserted, which is preferably also cast into the base 3 and in particular is also made of an electrically conductive material, advantageously of the same material as the carrier body 4. The inner sides of the two heating elements 5 facing one another contact the contact element 6. This establishes a closed circuit in each heating element 5 via the carrier body 4 and the contact element 6. The contact element 6 is located in the holding space of the carrier body 4 between the carrier body's two sheet metal sides. To prevent a short circuit, care must be taken that there is no electrical contact between the contact element and the carrier body 4.

The exterior of the carrier body 4 is provided with a protective film 7, which on the one hand is electrically insulating and ensures that the carrier body 4, including all the elements contained in the holding space of the carrier body, is chemically resistant to the fuel. On the other hand it prevents an undesirable electrolysis in the fuel. The protective film 7 has high heat resistance as well. The protective film 7 is formed particularly of a ceramic coating or a ceramic adhesive, e.g., an aluminum oxide on an oxide resin basis, which may optionally include carbon particles. Preferably the base 3 is also formed of this material. The protective film 7 encloses the carrier body 4 as well as any exposed sections of the contact element 6 up to the base 3, so that the protective film protects all the components of the heating device up to the base.

On the side opposite the carrier body 4, the base 3 has electrical contacts 10 and 11, such that the contact 10 is electrically connected to the carrier body 4 and the contact 11 is electrically connected to the contact element 6. The contacts 10 and 11 may optionally be formed integrally with the carrier body 4 or the contact element 6. For example, the carrier body and the contact element may protrude far enough through the base 3 that the free end face is exposed on the opposite side of the base.

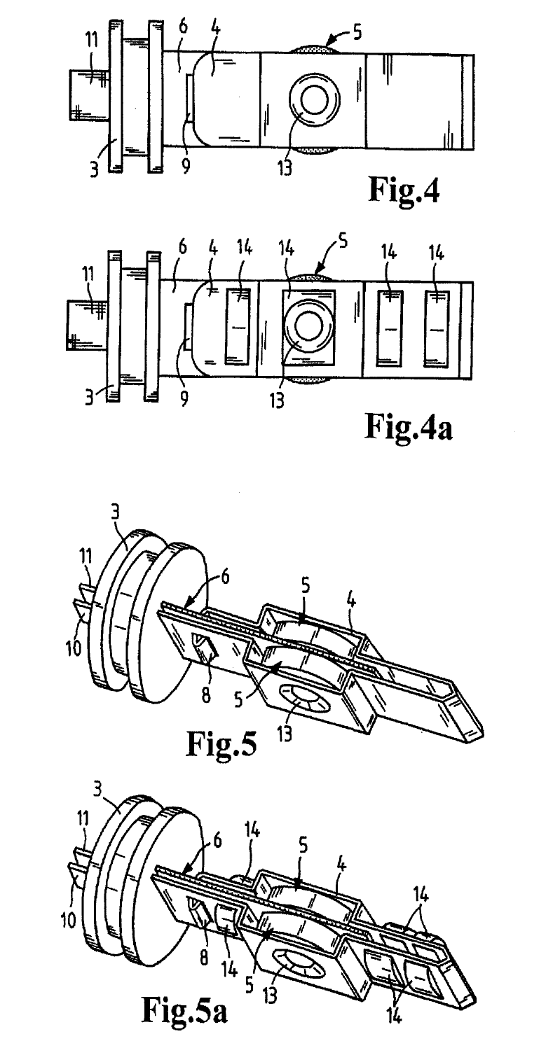

As may be seen in FIG. 1 and FIGS. 3 to 5, an end face portion of the carrier body 4 is bent to form a hook 8, which penetrates an opening 9 in the contact element 6 and in the opposite sheet metal side of the carrier body. The opening 9, particularly in the contact element 6, is large enough so that any unintended contact between the hook 8 and the contact element 6 is safely avoided.

The disk-shaped heating elements 5 are spring-loaded by means of spring steel clips 13, which are supported vertically to the longitudinal plane of the carrier body 4 in the indentations of each sheet metal side of the carrier body 4. These spring steel clips 13 firmly clamp the heating elements 5 in this direction.

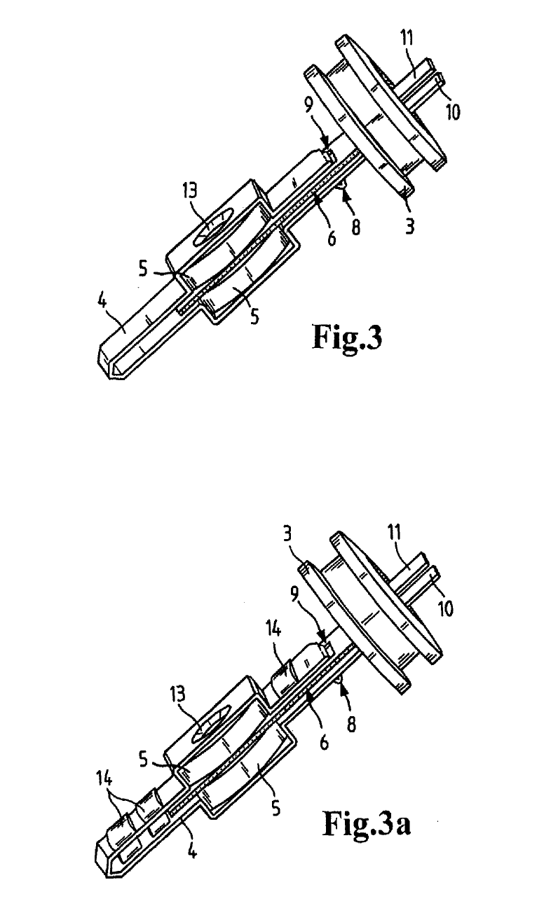

The protective film 7 shown in FIG. 1 advantageously encloses the carrier body 4 on all sides. Additional sheet metal pieces may optionally be provided on the lateral flanks, which are exposed in the views of FIGS. 3 and 5, to enclose the holding space for the heating elements 5 hermetically. The lateral flanks are also coated with the protective film.

The heating elements 5 are preferably positive temperature coefficient (PTC) elements.

FIG. 1a shows a modified embodiment of the heating device 1 depicted in FIG. 1. In this configuration, the carrier body 4′ has turbulence embossments 14, which are embossed out of the carrier body 4′ in the form of elevations.

FIG. 2a shows a section of the heating device 1 taken along line A-A of FIG. 1a. The turbulence embossments 14 are spaced apart from the heating elements 5, such that the carrier body 4′ contacts the heating elements 5 with its non-embossed areas. The turbulence embossments 14 are formed as closed embossments in the region of the heating elements 5 so as to prevent the fluid to be heated from penetrating the hollow space between the heating elements 5 and the carrier body 4′.

FIG. 2b shows a section of the heating device 1 taken along line B-B of FIG. 1a. The turbulence embossments 14 may be formed as loops, which are subject to fluid flow, or as closed elevations in the front region of the carrier body 4′.

FIGS. 3a, 4a and 5a correspond to FIGS. 3, 4 and 5. The carrier bodies 4′ have turbulence embossments 14, which serve to enlarge the surface.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A heating device for fuel comprising an electric heating element supported on a carrier body and a protective film insulating the heating element relative to the fuel to be heated, wherein the carrier body encloses the heating element, and the protective film is applied to the carrier body.

2. A heating device according to claim 1, wherein the carrier body is secured to a base, and the protective film encloses the carrier body up to the adjoining base.

3. A heating device according to claim 2, wherein the base is formed of the same material as the protective film.

4. A heating device according to claim 1, wherein the carrier body is formed as a sheet metal part.

5. A heating device according to claim 1, wherein the carrier body is constructed as an electric conductor, which is in electric contact with the heating element.

6. A heating device according to claim 1, wherein a contact element, which is formed separately from the carrier body, is in electric contact with the heating element.

7. A heating device according to claim 6, wherein the contact element is made of the same material as the carrier body.

8. A heating device according to claim 6, wherein two heating elements are enclosed by the carrier body, and the contact element lies between the two heating elements.

9. A heating device according to claim 1, wherein the carrier body is constructed as a one-piece component which encloses the heating element on at least two sides.

10. A heating device according to claim 1, wherein the insulating protective film comprises a ceramic coating.

11. A heating device according to claim 1, wherein the heating element is formed as a positive temperature coefficient heating element.
